(19) United States
(12) Patent Application Publication
(10) Pub. No.: US 2006/0155728 A1
(43) Pub. Date: Jul. 13, 2006

(54) Browser application and search engine integration

(76) Inventor: Jason Bosarge, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/320,185

(22) Filed: Dec. 28, 2005

Related U.S. Application Data
(60) Provisional application No. 60/640,134, filed on Dec. 29, 2004.

(51) Int. Cl. G06F 17/30

(52) U.S. Cl. 707/100

(57) ABSTRACT

Methods and systems for retrieving and rendering search results via the Internet can be implemented by a search engine that collates and collects multiple links in the background all tied to a single hyperlink click. The user of the search engine can set the number of back links tied to a single hyperlink URL thus creating an MRL (Multiple Resource Locator). If the user setting is five, for example, each single hyperlink click will load five pages into the browser, browser tabs, browser toolbar or within the ‘chrome’ of the browser. Also the number of links comprising an MRL can be dynamic.

### CROSS-REFERENCE TO RELATED APPLICATIONS

This application claims the benefit and priority of U.S. Provisional Application Ser. No. 60/640,134, filed Dec. 29, 2004, entitled “METHOD OF BROWSER APPLICATION AND SEARCH ENGINE INTEGRATION”, and which is incorporated herein by reference in its entirety.

### BACKGROUND OF THE INVENTION

1. The Field of the Invention

The present invention relates to a computer method and system for retrieving and rendering Internet search results and providing means for integration of said results into a browser application.

2. The Relevant Technology

The World Wide Web is especially conducive to information research. Many Web servers have been developed through which users can conduct research type activities. In general most Internet/Web-based search engines provide a list of hyperlinks to sites related to a user's typed query. Typically, the user goes to the search engine URL, and subsequently types one or more words of interest into a text-input box displayed by the engine. Each listed hyperlink if clicked will return a single resource (i.e., Web page) from an Internet Web-server to the users browser. Current search engines like Yahoo!, Google, MSNSearch, Teoma, Wisenut, AltaVista etc only allow for single-resource page loading that takes place one click at a time.

Search engines generally include links to all types of documents (.doc, .pdf), files (.mp3, .exe), images (.gif, jpg) and Web-pages etc. A user, who may be conducting research, may browse through the returned listings and select various hyperlinks to click. In this sense the browser and search engine interact in a method similar to the interaction one would encounter by clicking a hyperlink on any other Web page; a single resource is returned. In some instances when a Web page is loaded another resource “pops up” triggered by inline code script and usually consist of advertisement material.

Browsing/Viewing: The basic act of browsing/viewing of Internet/Web content hasn't really changed that much since the first browser appeared on the scene in the early 1990's. The basic “browsing” gist is rather simple: Either 1) type a single URL (or domain name) into a browser address bar or 2) click a hyper-link URL. The result of both actions is the same: to fetch a single Web-resource (URL) from a remote Web-server and then load that resource into the client browser for rendering and interpretation of HTML, XML, script or other code. The client “browser” can display HTML (Hyper Text Markup Language) so that the resource makes sense to the user. When a user types or clicks a URL the browser is directed to pull resources from a single remote Web server (i.e., www.yahoo.com). Users can have multiple browser windows open to view different Web pages. Some browser clients allow multiple windows to be opened inside the browser shell (i.e., Opera, Firefox) and allow navigation via tabbed buttons. Web pages are loaded in “tabs” within the same browser window, making it easy to switch back and forth among multiple web pages. Just about everything is faster with tabbed browsing: searching the web, reading news, reading Web mail, comparison-shopping etc.

In the above scenarios the user is required to type a URL name, click a hyperlink for each window or tab or open multiple Web pages at the same time via a single bookmark bound to multiple Web pages. These actions all take place within the browser application proper and are not integrated with an ‘outside’ Web page or search engine.

Searching: In general most Internet/Web-based search engines provide a list of hyperlinks to sites related to a user's typed query. Typically, the user goes to the search engine URL, and subsequently types one or more words of interest into a text-input box displayed by the engine. Each listed hyperlink if clicked will return a single resource (i.e., Web page) from an Internet Web-server to the users browser. The user can open multiple Web pages or documents which load into another and different browser application via a right-click of the mouse and choosing the ‘open in new window’ option. If desired a user can view a Web page of search result listings and right-click and open all the links on the page—this process takes (in the case of a ten page listing) 10 right-click steps and choosing the option to ‘open in new window’ which a takes considerable amount of time. The user can then view each Web page individually. Very often the user does not know if a page is truly relevant to their search query until the page has actually loaded.

Extensions: Some browsers allow for the creation of third-party extensions that are utilized to give the browser extended functionality. One such extension for the Mozilla/Firefox browser is an application called Linky. Linky allows the user to open all links on a page or just image links on a page at once. The user can choose not to open some links, such as already visited links and the links can be opened in either new windows or tabs. Linky is not however integrated into a Web-page-based search engine in the sense that it requires the additional step of right-clicking (with a mouse) to bring up a ‘context’ menu that then allows the user to determine which links or image links will load.

Advertising click-throughs or pay-per-click advertising: This advertising model is based on the desire for advertisers to pay only for guaranteed results in terms of traffic, rather than on a brand-building view or impression basis. A Pay-Per-click (PPC) campaign lets users determine exactly who comes to a specified website. Additionally, an important advantage is that the user only pays for actual click-throughs to a certain pre-determined site. In other words, the advertiser will pay only if a Web user clicks on a link or banner and lands on the specified site (also called pay-for-performance advertising). If a Web user only sees an advertiser link, but does not click through, this is called an impression. The user does not pay for the impression. PPC advertising is based on keyword selection. The majority of the PPC Internet advertising market revolves around choosing the correct search terms and keywords.

Organizing links: The act of storing/saving or organizing Web pages hasn't changed much since the debut of the first Web browser. The user saves links or URL's in a file system known as “bookmarks” or “favorites”. The system stores URL's or Web-site addresses locally for later retrieval by the user. When a user clicks a “favorite” or “bookmark” the browser is directed to a single Web-address (i.e., www.yahoo.com) Some Web sites (furl.com, blink.com) allow users to store Web “bookmarks” on a central server.

### BRIEF SUMMARY OF THE INVENTION

The present invention provides methods systems and computer program products for searching, researching and browsing in which Web users can quickly and efficiently view, sift and discard large numbers of Web pages in less time than is now currently possible. The present invention can also be used to help view search result listings in dynamically formed affinity groups (or corpus) wherein multiple URL's are represented by a single URL or MRL (Multiple Resource Locator) or (XMLUrl) with the aim of launching or viewing in real-time all URL's contained in an affinity group or corpus (MRL) with a single mouse click or keyboard event and not have to view each Web page resource individually via separate click events for each Web page as is currently the norm. Another key aspect of the invention allows for the loading of ancillary pages to load into “tabs” or windows when a single domain URL is typed into a browser address bar. One suggested implementation is to use what we call Supplementary Load Tags to allow the browser to determine the additional resources to load. If the main page typed by the user is a http page addressed to “//www.XR45” at the domain “.com”—the HTML for that default page can contain the following or similar code:
<SLT>http://www.XR45.com/promotion1.php</SLT>
<SLT>http://www.XR45.com/promotion2.php</SLT>
<SLT>http://www.XR45.com/aboutus.php</SLT>
<SLT>http://www.SLTAds.com/ads/load.aspx?siteid=1220&userid=4004</SLT>
   The browser or Internet application parses each “SLT Tag” (Supplementary Load Tag) and automatically loads each SLT-defined page in a separate tab window. The loading can be based on SLT processing rules of each individual browser i.e. max number of ancillary pages to load etc. In the above case the main page will load, in this case XR45.com and each page defined by SLT Tags will also load into “tabs” or windows. One of the loaded pages points to SLTAds.com. SLTads.com can load dynamic third-party content into a tab window. The content can be contextually related to the Main Page content or other related sub-domain content. Amount of time a user spends on that tab could be tracked for effectiveness metrics to the advertiser.

According to some aspects of the invention, it is anticipated that Web searchers will no longer need to go through the laborious process of scrolling to a desired single site listing then click on that listing, then view the resource associated with that listing, then click the back button to return to the search result listings and then repeat that process. It is further anticipated that Web users will no longer need to open individual Web pages one at a time into the same browser window or into ‘new browser windows’ or into ‘tabs’ or ‘tabbed-windows’ for tab-enabled browser applications wherein significant time resources are consumed where each Web page resource is treated as a separate document in the search listing and at the click event. In some embodiments, each Web resource will be loaded simultaneously into a browser application and that each Web resource will be represented by a button (image, icon, text, tab etc.) located in the browser application chrome. Each resource will then become viewable when the resources' button is clicked.

Some possible methods utilized in the present invention for loading multiple sites into a browser application from a search page or general Web page are as follows:

<a href=“q.php?u1=http://www.yahoo.com&u2=http://www.google.com&u3=http://www.netscape.com”>Launch All</a>

<a href-“<Site><Title>Yahoo!</Title><URL>http://www.yahoo.com</URL><Title>Google</Title><URL>http://www.google.com<URL></Site>”>Launch All</a>

<a href-“<MRL><URL>http://www.yahoo.com</URL><URL>http://www.google.com</URL><URL>http://www.msn.com</URL></MRL>”>Launch All</a>

Two types of Multi-URL (MRL) are listed above: the first is a querystring-based URL that passes in URL values in variables like u1, u2, u3 etc. The other two are XML URL's that use standard XML-type tags to list the URL's that will be launched into the browser application.

It is further anticipated that information searchers or Web searchers will no longer have to return to the search result listing page when rather upon the close of a single document or Web resource the very next resource listing (URL) in the search result listing page is automatically loaded into the existing browser instance or in a ‘tab’ for tab-enabled browsers or in a button for plug-in or toolbar apps located in the browser application chrome. In one embodiment it is desirable that this automatically loaded resource be loaded in the ‘background’ and represented by a button or tab located in the browser application chrome and accessible via a single click-event. It is understood that as the user closes existing buttons in any number that that a corresponding amount of resources will dynamically load in a sequential manner where the order is determined by the search result-listing page.

The following URL's shown below indicate various methods by which one may pass multiple URL's to a receiving application for the purpose of launching multiple Web pages, documents or resources.

<a href=“<MRL ID=1><URL>http://www.yahoo.com</URL><ID>1</ID><URL>http://www.google.com</URL><ID>2</ID><URL>http://www.msnsearch.com</URL><ID>3</ID><MRL>”>Launch Set 1</a>

<a href=“<MRL ID=2><URL>http://www.gigablast.com<URL><ID>4</ID><URL>http://www.lycos.com</URL><ID>5</ID><URL>http://www.teoma.com</URL><ID>6</ID></MRL>”>Launch Set 2</a>

<a href=“<MRL ID=3><URL>http://www.sun.com<URL><ID>7</ID><URL>http://www.linux.com</URL><ID>8</ID><URL>http://www.apple.com</URL><ID>9</ID></MRL>”>Launch Set 3</a>

Another embodiment of the present invention allows the user to simply type a search query in a Web page text field and forego the actual search results listing page and begin loading the first N number of Web pages that are resulted from the search result listings directly into the browser. So in this event the first 8 Web pages from a search result listing may auto load into the browser application.

In another embodiment of the present invention the user can maintain the state of each Web resource or document that is viewable in the toolbar or browser area or tab area. A means is provided whereby the user can ‘check’ or ‘pin’ a certain tab or button (that represents a resource) so that that resource stays in place or remains visible when the next set or group of URL's are loaded into the browser application. Some examples of pinning a resource according to this method, are illustrated in the images appended to this application.

Another embodiment of the present invention allows for the easy reading of books or any chapter-based or sequentially organized content like online magazine or news articles. This method is achieved by providing means that when the user reads to the bottom of a page the next page is auto-loaded into the browser into another browser object and is viewable via a simple tab or button click. The next page auto-load can be triggered at scroll-points on a page or when the user reaches a certain point in the document or after a certain amount of time has passed and if the document has the current focus.

Another embodiment of the present invention allows for the saving of individual URL's by the user that comprise the making of a personal MRL set located on a central server or a local computer. When a save event is invoked either single or batch the user is shown the URL and resource information on a Web page. As each URL is saved the list continues to grow if the search query is the same. If the search query is changed a new set is created under the new search query name. The user has the option of editing or deleting the title, URL, description or any other keyword or meta-data associated with each set. The user can then build more complete personal sets (MRL's) that others may find useful. The user may then share those sets out to the search results for others to view and benefit from the time and effort that went into the making of those shared sets and research.

It is further understood that existing search engine processes wherein each Web page resource is treated as a single document in the search result listing and at the click event are undesirable and all together inefficient and not conducive to fast searching and research processes that may be realized by the present invention described herein.

It is therefore a principal object of the present invention to devise a method and system for matching a unique identifier in a single hyperlink URL or a single domain name to a corpus or collection of URL's. The related URL's are retrieved and are all loaded into the Web browser by opening a series of consecutive “windows” each containing the retrieved data from said URL's and rendering each page in a separate browser instance. The browser instance may be contained in a single browser shell or consist of multiple browser windows. This method prevents the need to click a different hyperlink for each resource.

This invention changes the concept of a URL as a single resource locator into a “multiple resource locator” by binding a multi-URL corpus into a single URL for search-result display listings. Each individual corpus in the result-set is identified by an “MRL” or Multiple Resource Locator and is then operational via a single-click event. As a stand-alone ‘Super-URL’ it's a great concept but when put in the context of a search engine the real power emerges.

The ability to quickly consume vast amounts of search data without the usual click and scroll methods currently employed has the potential to change the fundamental ways users currently conduct research on the Internet. While click and scroll is still necessary the amount of effort required has been drastically reduced by a large factor. The invention also changes the basic concept of how search results are rendered and presented to the user. To date no search engine has changed the rules in such a drastic manner as the current invention in terms of a simple display of search results and the amazing ease with which those results are consumed and utilized in mass while at the same time maintaining the familiarity, look, and feel of current implementations. In today's Internet, highly relevant search results are fast becoming a commodity and the search needs of Internet users are rapidly moving to a new phase. The critical components of next-generation search are presentation and the ability to comprehend and sift large volumes of data with ease and that is the aim of the present invention.

In one preferred embodiment the invention employs the use of a search engine data feed typically comprised of an XML document that is parsed for various data elements. The XML data elements or nodes are comprised of a title, URL, description, page extraction, document size and other information related to Web pages on the Internet. The data feed is typically XML but can be in the form of records or rows of data directly from a database such as MSSQL Server, MYSQL or Oracle. Any other data form may also be utilized.

In a typical search engine each search result listing in the data feed would be displayed as is. The present invention however uses various computer algorithms to intelligently parse the data feed into compressed collections of affinity groups or ‘Sets’ where each group has a single URL representation that when clicked by a user will automatically load or render all documents in the affinity group. The algorithm analyzes each data node in the complete data feed and begins grouping URL's titles, descriptions, text snippets etc into various logical compilations. Any number of algorithms can be used to group the URL's obtained from a search into categories or groups based on any need or preference. It will be appreciated that the algorithms can be established to group the URLs based on predetermined criteria set by the user, a third party or a combination of both. Algorithms can also be set to control the size of the groups, by limiting the number of URLs assigned to any MRL.

In one embodiment the grouping takes the first 10 Web page listings (each Web page or document listing is typically comprised of title, URL, description, size, lastmod, etc.) and builds a single group title out of the 10 Web page or document titles. Each Web page title is parsed and compared against the query to determine what title snippets will make up the final group title with more weight given to a match of query and title keywords found in each Web page document title. The group title is then rendered as a hyperlink that is comprised of either a single id number that represents URL's in a database or different XML file or each URL is embedded in the hyperlink as variable values such as bin/q.asp?url1=n1&url2=n&url3=n3 etc where n1, n2 and n3 are actual complete or partial URL's to be interpreted by the browser or browser plug-in and each is rendered either visible or non-visible and viewable with each button or tab click.

Each URL from the ten listings are then extracted and grouped near the single title so that now a multiple of URL's has a single representation via one URL rather than each URL having independent representation by separate titles. The user can then quickly view a single title hyperlink and its associated URLs and determines that that group of URLs is the relevant group to launch and render in the browser by clicking the group title. When the group URL is clicked a Web browser is capable of recognizing that a “special” (in this case a ‘MRL’) URL has been clicked and certain actions must now take place. Typically when a URL is clicked a Web browser needs to render a single resource. In the present invention the Web browser application recognizes that a single click event has a multiple of URL's associated with the click-event and each URL is parsed and rendered into an array and an array of browser ‘objects’ are created to render each URL in the URL array. The URL array can be created by pulling each URL in the group from a database based on a group id or from delimited querystring values embedded in a hyperlink and passed into a browser application as a result of a single click or as the result of a user typing a URL directly into a browser address bar.

After the click-event or a URL is typed into a browser address bar the complete group of documents are loaded or rendered in simultaneity in a browser or browser plug-in that is capable of rendering multiple Web pages or multiple browser objects. The user can then view all resources associated with the affinity group on the search results listing page(s). This process allows the user the ability to consume information much faster and process and comprehend search result data much faster than before. In this particular instance the user can view 10 documents or Web pages in about the same amount of time it currently takes to view a single document or Web page. This method allows the user the ability to see each page and determine the overall relevancy in relation to a specific query input by the user. Each page can be viewed in very quick succession by a single button or tab click and a determination can quickly be made as to the desire of the user to keep or close that page and whether or not to open the next group or affinity group.

When a button or tab is closed and new button or tab appears at the end of the button list and loads the next Web page or document from the next set or corpus in the search result listing (each of the remaining buttons slide over to accommodate the newly created button)—this allows the user to quickly move through documents at a rapid pace WITHOUT the need to return to the search results page. This is a key part of the present invention to allow the quick consumption and sifting of search result data: the user can maintain the critical and needed focus on the browser window(s) and while discarding pages ‘at will’ the next page(s) from the search page will automatically load in the background and will be loaded (or be loading) when the user clicks the button to view that page. In one embodiment this is achieved by giving all individual URL's on a search result page a unique sequential ID such as 23,24,25,26,27 etc.

The browser application is aware that the last page to load from an affinity group or corpus had an ID of 24 and that currently loaded into the browser application are pages with ID's of 19, 20,21,22,23 and 24. The user then decides to close pages 19 and 23. At this point the browser application checks the last page ID to load and makes a call to a database system or XML server etc and retrieves the Web page with an ID of 25 and 26 and begins loading those pages in simultaneity into the browser. This process repeats itself until the user has found all documents needed for a specific query.

When a button is ‘checked’ or the save-page option in the button menu is chosen the Web page that is in view is automatically saved to the server, the user is shown the Web page of saved pages and they can click ‘back’ to go back to the page they just saved. Saved pages get automatically grouped into Sets of N IF the query (which is checked upon every save) is the same. If the query is not the same then a new Set is created. When a user closes a button the next unloaded/unviewed page in the search result listing automatically loads in to the viewable area. In one embodiment all URL's in the search result listing have unique sequential ID's so the toolbar can deduce what page it needs to load next.

In another embodiment, the search result Web page may be modified to include “collection indicators” meaning that analysis was performed on standard search result listings and dynamic groupings were determined to allow multiple listings to be opened and rendered via a single URL click. The collection indicators are rendered in the form of hyperlinks or clickable images, icons etc and when hovered with a pointing device various markers indicate what search result listings are grouped into a single click. This is shown and described in more detail below in reference to FIG. 4.

The invention employs conventional global communication network components for using the same adapted to hook up via a modem, network card, Bluetooth interface or any other interface to any known data transmission networks such as terrestrial and wireless phone networks, optical data transmission networks, local area networks (LAN), wide area networks (WAN) and all other known and unknown transmission networks and mediums to access a central computer or any computer to parse search data feeds. It will communicate directly and autarkic (without means of a PC, Laptop, or personal organizer) directly with a local or remote server or computer, which handles and keeps track of all individual querystrings. This allows confidential access only by authorized screening devices to a large continually updated database.

As described herein, the present invention provides a far more efficient method for consuming, comprehending, sifting, saving, and viewing search data and corresponding Web pages and documents. One overall result of this invention is that the user can quickly move through N number of documents and determine relevancy but only a single click was needed to render the multiple documents or Web pages. The present invention removes considerable amounts of frustration often experienced by Web and more specifically search engine users. Significant time savings are gained by utilizing the concept of an ‘MRL’ or a Multiple Resource Locator rather than a URL or Uniform Resource Locator. The time savings are quite significant for general Web browsing and more specifically for search engine searching and research. Significant time savings are also realized by the integration of the search engine result listings in with the actual browser application utilized by the user. Significant time savings are gained by allowing the user the ability to stay focused on looking at actual Web pages when one page is closed the next Web page in the search result list auto-loads into the browser. The browser or “browser application” can be any type of device one might to view Web pages and documents.

It is also desirable that this system be readily implemented at reasonable cost and readily understood by users without having to accept unfamiliar search concepts.

These and other objects and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates one embodiment of a Webpage screen shot according to aspects of the invention;

FIG. 1B illustrates one embodiment of a Webpage screen shot according to aspects of the invention;

FIG. 1C illustrates one embodiment of a Webpage screen shot according to aspects of the invention;

FIG. 2 illustrates one embodiment of a Webpage screen shot according to aspects of the invention;

FIG. 3 illustrates one embodiment of a Webpage screen shot according to aspects of the invention;

FIG. 4 illustrates one embodiment of a Webpage screen shot according to aspects of the invention;

FIG. 5A illustrates one embodiment of a Webpage screen shot according to aspects of the invention;

FIG. 5B illustrates one embodiment of a Webpage screen shot according to aspects of the invention; and

FIG. 5C illustrates one embodiment of a Webpage screen shot according to aspects of the invention.

### DETAILED DESCRIPTION OF THE PREFERRED EMBODIMENTS

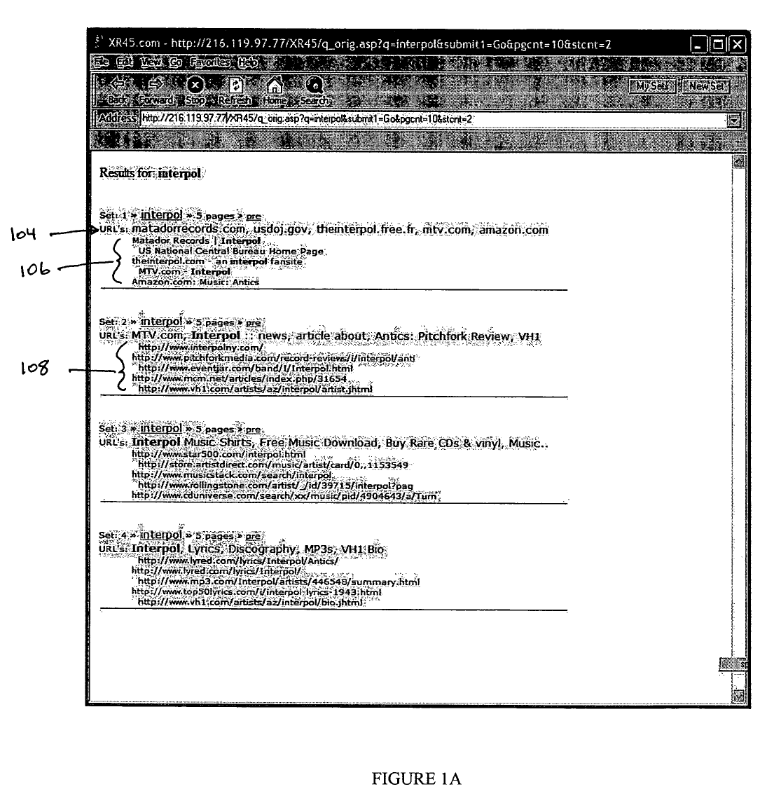

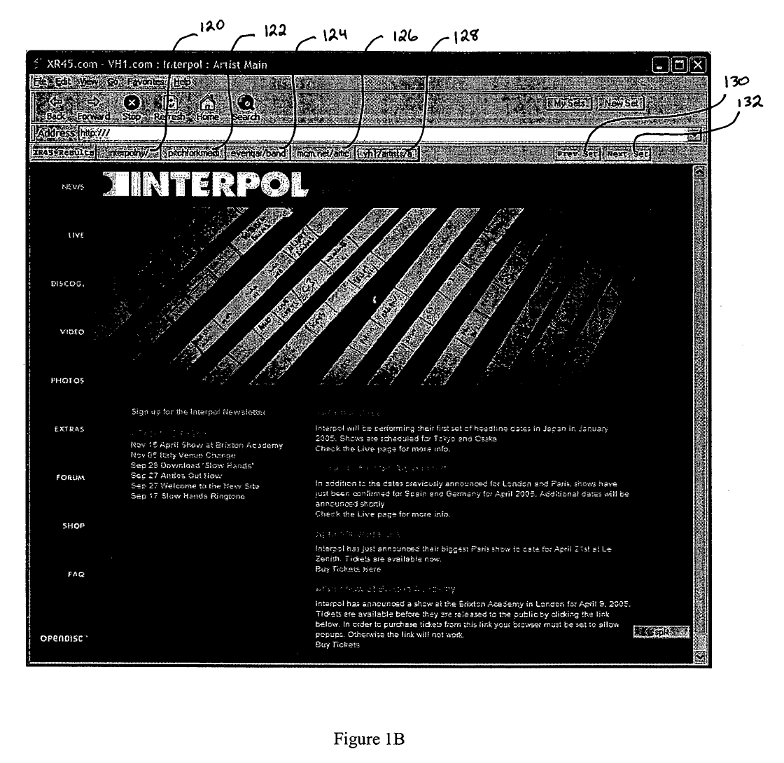

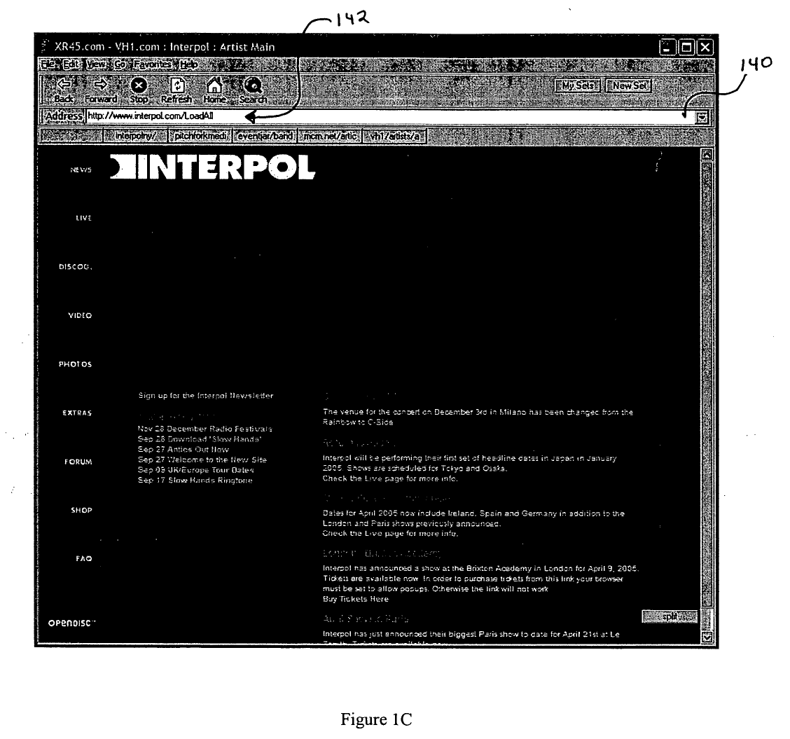

It will be noted in FIG. 1A that search results are returned in groups called ‘Sets’ 102 (or corpus) that dynamically combine multiple URL's into one single URL in order to facilitate launching multiple pages in one click. In this embodiment each ‘set’ 102 has the same title (Interpol) and the title is the same as the users' actual search term. In this embodiment each ‘set’ 102 contains five independent URL's. In this embodiment Set 1 shows a listing 104 of all the URL's contained in this Set and below the URL listing are the actual Web page titles 106 of each URL in the Set. In this embodiment clicking the hyperlink ‘Interpol’ in Set 1 will launch matadorrecords.com, usdoj.gov, theinterpol.free.fr, mtv.com and amazon.com at the same time into a device (modified browser, toolbar, tab-enabled browser, etc.) capable of loading all the Web pages together. In this embodiment a custom built browser is utilized to facilitate the loading of all the pages via one click.

It will also be noted that Set 1 in FIG. 1A is comprised of commercial links. Meaning the entire set was paid for by advertisers. When the user clicks Set 1 all advertiser pages will load at the same time. However advertisers are not charged for the click-through that launched the complete Set. Instead the advertiser is only charged when the user clicks the button or tab on the browser to view the Web page or when the advertiser is the first link in the set as the first link in the set always loads first.

It will be noted in FIG. 1B that once the hyperlink ‘Interpol’ Set 2 (from FIG. 1A) is clicked the five URL's 108 contained in that Set are all loaded into the browser simultaneously. In this embodiment the browser recognizes when it is at a specific URL, in this case the URL is XR45.com/q.asp?xid=67584. The browser parses the URL to determine if an ‘xid’ exists, if so a request is made to a data-base server and the xid is passed into a SQL query. An XML file is returned in response to the query and the XML files are parsed by the browser and the Set URL's and Set Web page titles are determined. Then, each URL is loaded and the Web page titles are assigned to each button or tab. In this embodiment each Web page is represented by a button 120, 122, 124, 126, 182 (under the browser address bar) that may contain as the button title the actual Web page title and/or URL, etc. Each of the Web pages (represented by each button) are all fully loaded by the time the user clicks the button to view the page preventing the typical wait-time of the page load normally experienced by the user. It will also be noted that the browser contains ‘Prev Set’ 130 and ‘Next Set’ 132 buttons to allow the user to load (preview) the next or previous Sets contained in the search result listing of FIG. 1A. This prevents the need for the user to return to the search-listing page to load the next Set of URL's represented by the Multiple Resource Locator (MRL).

It will be noted in FIG. 1C the same Web pages as listed in FIG. 1B have loaded into the browser. However the dynamic loading of all the Web pages was not due the clicking of a hyperlink in a search result set but rather by simply typing in a specific domain address in the browser address bar 140. The address can correspond to an MRL previously associated with one or more URLs, which is stored at the server or another location, for example. In this figure and embodiment the typed URL is: http://www.interpol.com/LoadAll (142), which typed URL is actually a previously established MRL and was therefore interpreted by the browser as an instruction to load a multitude of Web pages into ‘tabs’ or ‘buttons’ instead of opening a single resource.

It will be appreciated that the foregoing embodiment can be useful in one sense in that an advertiser may want to advertise a single URL in a magazine, newspaper, radio, etc., and have a main Web page load first then load additional pages at the same time in a non-intrusive manner that the user can view at will. Accordingly, the advertiser or information provider can provide what appears to be a URL, but what is in actuality a MRL, via any publication or media outlet. Thereafter, when readers or listeners type in the MRL, the group of Web pages associated with the MRL will be loaded.

In one embodiment, the MRL can include URLs to a particular theme such as a home advertisement where the user can view pictures of the house in one view, information about the owners in another window (button or tab) and information about the broker in another window and then information about the finance company or bank in yet another window. This type of grouping would be a themed Set. This prevents the user from having to click around on the advertisers Web site to get various disparate information and instead it is presented to the user directly for easy access.

In other embodiments, the MRL can include groupings of documents that may or may not correspond to a theme.

When the tabs are created for the various resources identified by the MRL, they can be arranged and displayed in any order and based on any criteria. Some criteria can include relevance (e.g., search terms, sources of the MRL, and so forth), preference established by advertising criteria (e.g., based on who pays the most), random order, alternating order, user defined preferences, display requirements (e.g., position the smallest or fastest loading pages in the first tabs, as they are the most likely to be opened first).

In some embodiments, the tabs corresponding to the multiple resources can be closed individually only. In other embodiments, one or more of the tabs can be closed collectively and simultaneously by selecting a close option displayed with the browser UI. For example, there can be an option to close all tabs but the tab corresponding to the presently displayed page. There can be an option to close all unopened tabs. There can also be options to close one or more tabs based on filter settings. For example, filter settings can be based on content in the corresponding resources (e.g., language type, offensive language thresholds, adult content thresholds, or any other content classification), programming or protocols associated with the resources, security features or risks associated with the resources, types of content (e.g., advertising, images, text-only, mixed text and images, chat or community rooms), and so forth.

It will also be appreciated that many of the features and algorithms used to group URLs into MRLs for search engines can also be utilized to provide heightened filtering for removing or identifying particular URLs within a MRL. This is particularly true when the MRL includes numerous URLS.

In a correspondingly similar embodiment, the browser UIs can also include focus buttons for identifying desired features or aspects of searched for resources. In these circumstances, all tabs that do not correspond to a resource having the desired features or aspects that are searched for will be closed, leaving only the desired URLs.

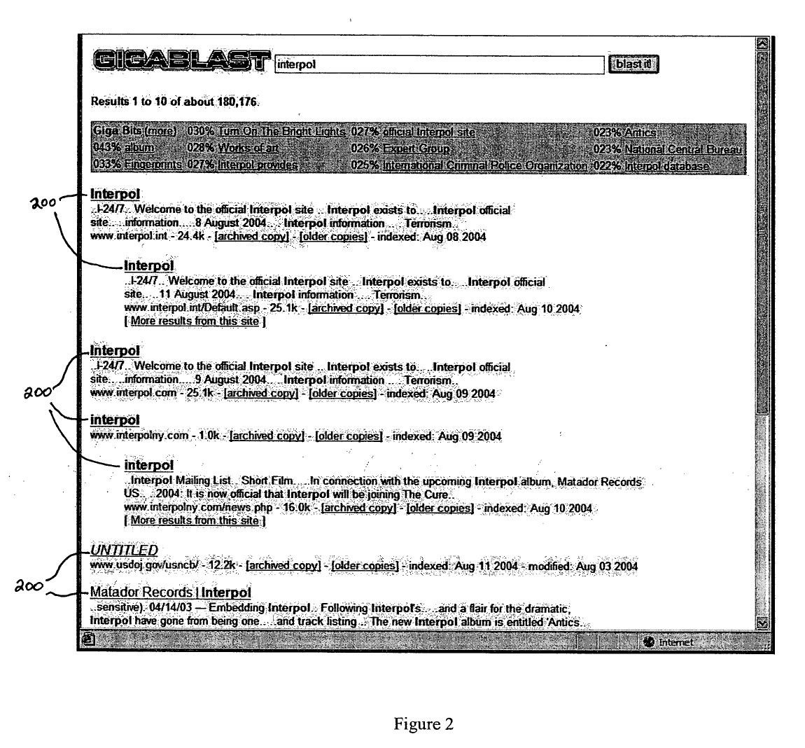

FIG. 2 contains search results that are typical of the majority of search engines on the Web today. Each link 200 represents a single Web page resource. It will be noted that to open the first 5 links in this result listing the user is required to click each link separately and open the Web page in the same window, a different window or a different tab for tab enabled browsers. By comparison it should be noted that to open the same first five links utilizing the present invention only requires a single click by the user. This greatly facilitates the ability of the user to research and consume search data much faster than is currently possible. Depending on connection speed and computer power a single Set may contain ten links or more to increase research and consumption abilities even more.

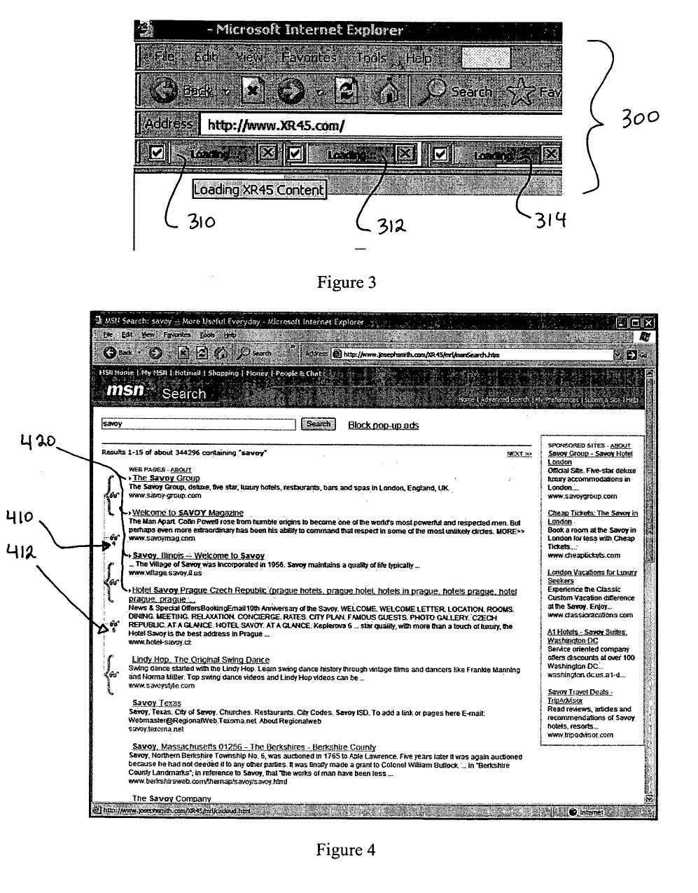

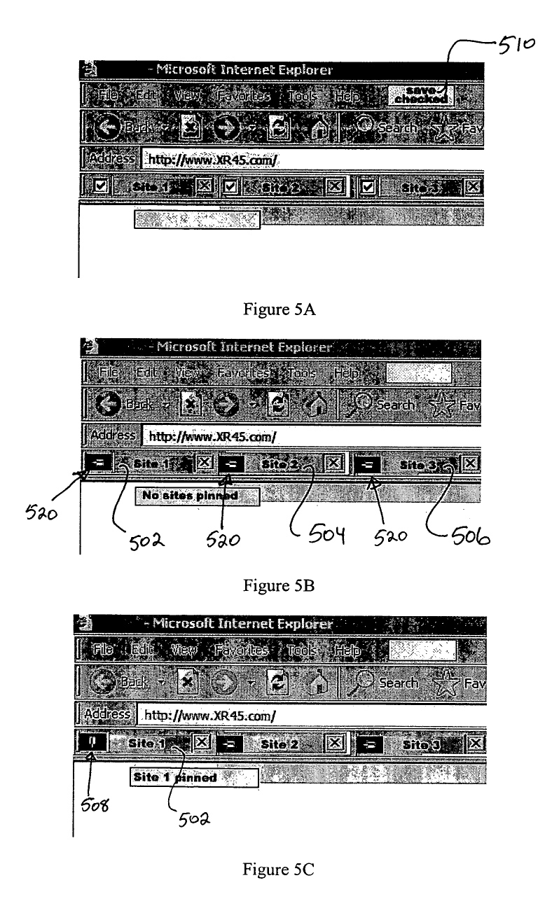

FIG. 3 shows the Web browser 300 moments after a user clicks a MRL link from a Web page. In this embodiment that single click loads three separate and different Web pages. Each button 310, 312, 314 has the caption of “Loading . . .” if the pages have not yet rendered. Each button has a check-box for saving and an X for closing. If a user likes a particular Web page they can check the box on that button. The user can then click a ‘Save Checked’ button 510 or other button to have all of the checked Web pages be automatically saved to a local or remote drive and/or database system. One embodiment of a browser UI including the ‘Save Checked’ button 510 is included in FIG. 5A, described in more detail below. The user can also close the buttons or pages they do not want. The user can then proceed to load the next Set of Web pages. They can either go back to the search results button and click the next desired Set or choose ‘Next Set’ 132 on the browser. Either way the next Set of Web pages will load in the browser in real time. The user then repeats the above process of checking the pages he wants and discarding the pages he does not want. This process allows the user to quickly and efficiently build saved Sets that he can come back to at any time and load into the browser at will.

When a user clicks ‘Save Checked’ 510 the process checks the query term(s) used for that search and makes that query name the name of the Set that is being saved. If the user loads another Set and checks more buttons and then clicks Save Checked 510 the query term is again checked, if it is the same a previously saved Set the checked Web pages are appended to the existing saved Set. If the query term does not exist as a saved Set then a new Set is created.

Another method for returning MRL-based search results is indicated in FIG. 4. To the left of the search results are “collection indicators” 410, 412 when hovered over indicate which group of URL's will launch when the collection indicator 410 is clicked. The actual search results are returned as normal but the groupings occur via the collection indicators 410, 412. In FIG. 4 the arrows 420 next to the first 4 search links are the result of the pointer being hovered over the “4” collection indicator 410. Collection indicators can be comprised of any type of clickable link or image. When the collection indicators 410, 412 are hovered over, they should indicate which URL's will launch with the single click of the indicator. In some embodiments, the collection indicators can correspond to an exclusive list of URLs. In other embodiments, the collection indicators can correspond to URLs that are shared amongst different MRL groupings.

In yet other embodiments, a user can dynamically create a MRL by selecting a section of a display that includes multiple links to a plurality of different URLs. By doing this, the browser groups all of the multiple links into a single MRL and launches the MRL.

As described above, the present invention provides many applications for MRLs, including search engines and links on web pages. Users can also directly access a MRL through a web browser by typing in the appropriate web address where the MRL is located. Typically, the MRL is stored at the server. MRLs can be stored in a generic form and made applicable to all users. This can be useful, for example, in the search engine context. In other embodiments, the MRLs can also be stored by the server for only limited access, such as when users create or customize their own MRLs.

It will be appreciated that once a MRL is created, it can also be customized to include or omit certain URLS. In some circumstances, for example, the MRL might delete a URL from a MRL if it has been unable to access a URL previously associated with the MRL. A user can also customize a MRL by explicitly adding or deleting URLs with the assistance of any appropriate API or UI.

It will also be appreciated that in some instances, a MRL might only load or display some of the URLs that have been associated with it. For example, depending on the filtering software and browser settings associated with a particular end-user, one or more URLs might be blocked or otherwise prevented from loading. In these situations, a user can be asked to over-ride settings or, in the alternative, the URLs of the MRL can be loaded with the exception of the blocked URLs. Accordingly, the MRL might load differently, from time to time, depending on the current browser and filter settings.

According to one embodiment, as generally described above, and as shown in the screenshot of a browser UI in FIG. 5A, a ‘save checked’ button 510 allows the user to save all documents or Web pages in a batch mode or one at a time. When the save checked button is clicked a Web page can be shown that indicates all pages are saved and the search query can become the title to the saved resources. The user then has access to those saved ‘sets’ and can later modify the set or view the resources.

According to another embodiment, as reflected by FIG. 5B, each site button (or tab) 502, 504, 506 is displayed with an optional ‘pin’ button 520 that can be utilized by the user to keep the corresponding resource in place as other resources are discarded or as other resources are loaded in via the search result listings or other means, as described above. The ‘pins’ 520 located to the left of each site name are all pointing to the left. When activated the pin icon will point down or reflect a change in state in some other manner, as shown by icon 508 in FIG. 5C.

For example, the above image shows the pin icon 508 of Site 1 502 in a state of activation. In particular, the icon 508 next to the Site 1 button 502 is pointing down signifying that that resource will remain in place as the user continues to view other resources by loading new MRL's into the browser.

It should also be appreciated that the foregoing description of the invention extends to methods, systems and computer program products that can include a special purpose or general-purpose computer including various computer hardware. Accordingly, the foregoing description for accessing, creating, modifying, managing, or otherwise using MRLs can be implemented with the use of one or more computing devices, computing networks, and one or more computer-readable media for carrying or having computer-executable instructions or data structures stored thereon and that implement the disclosed methods.

As defined herein, computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Finally, while the present invention may be embodied in other specific forms without departing from its spirit or essential characteristics, it will be appreciated that the present invention provides many new and useful methods, systems and computer program products for improving current Web browsing and Web searching with the use of MRLs. Accordingly, described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of generating a search result list in real-time in response to a search request from a user using a computer network, comprising:
maintaining a database including a plurality of search listings, wherein each search listing is comprised of unrelated and ungrouped documents that are dynamically grouped into a single relevant corpus, and wherein entire corpus contents of the single relevant corpus are presented and rendered to a user as the result of a single action, and wherein the single relevant corpus is treated as a single document in a search result set, such that each corpus of URL's of the single relevant corpus are assigned a single URL for the purpose of rendering a complete corpus of URL's in response to the single action;
receiving a search request from the user;
receiving and interpreting the single action as a request to simultaneously render all URL's corresponding to the documents contained in the single relevant corpus; and
displaying the URL's corresponding to the documents contained in the single relevant corpus, wherein a series of corpora each with a same title are collectively treated as single documents in a search result set.

2. A method as recited in claim 1, wherein the single relevant corpus is a dynamically created corpus having a corpus name comprising a query term utilized in the search request.

3. A method as recited in claim 1, wherein the single action is a selection of a hyperlink.

4. A method as recited in claim 1, wherein the single action is a mouse click.

5. A method as recited in claim 1, whereby individual documents of the corpora are searched and indexed to determine a most relevant corpus from the corpora.

6. A method as recited in claim 1, whereby tabs or buttons are utilized to view multiple pages from a Web page or Web page search engine before during or after the corpus documents have loaded.

7. A method as recited in claim 1, whereby an information result set comprising at least one of titles, descriptions, and URL's are grouped into a single result set comprising snippets of information from a larger result set.

8. A method as recited in claim 1, further comprising: receiving a single selection of a URL; and displaying multiple Web pages as a result of the single selection.

9. A method as recited in claim 1, whereby a single event counts as a ‘click-through’ for each link in a corpus of URL's.

10. A method as recited in claim 1, whereby the single event counts as a ‘click-through’ in order to calculate payments.

11. A method as recited in claim 1, whereby a user chooses which of a plurality of items, including at least one of documents, links or pages will be launched with the one action.

12. A method as recited in claim 1, further including an act of monitoring a load status of each of the URL's to determine which page-to show first.

13. A method as recited in claim 1, whereby a plurality of Web pages or Internet resources load into a single browser instance in simultaneity as the result of typing a domain name URL in the browser address bar.

14. A method as recited in claim 13, whereby the plurality of Web pages or Internet resources have a cohesive theme and are loaded into a single browser instance in simultaneity.

15. A method as recited in claim 13, whereby when one Internet resource is closed a new button or tab appears representing a next Internet resource corresponding to the search request.

16. A method as recited in claim 1, whereby each URL has a sequential ID for dynamic loading and identification.

17. A method as recited in claim 1, whereby a user can determine how many URL's are grouped into a single hyperlink click.

18. A computer program product comprising one or more computer-readable media having computer-executable instructions for implementing the method recited in claim 1.

19. A computer program product as recited in claim 18, wherein the method further comprises:
receiving a single selection of a URL; and
displaying multiple Web pages as a result of the single selection, wherein the Web pages are loaded simultaneously.

20. A computing system comprising one or more computer-readable media having computer-executable instructions for implementing the method recited in claim 1.

21. A method as recited in claim 13, whereby a plurality of Web pages or Internet resources load into a single browser instance in simultaneity as the result of the browser parsing HTML or XML tags to determine what ancillary resources or pages to load.

22. A method as recited in claim 1, whereby the click event of an ancillary tab or window counts as a ‘click-through’ in order to calculate payments.

23. A method as recited in claim 13, whereby the click event of an ancillary tab or window counts as a ‘click-through’ in order to calculate payments.

24. A method as recited in claim 1, whereby a tab window receives focus and makes an HTTP call to a server to register a click event.
